(19) United States
(12) Patent Application Publication
(10) Pub. No.: US 2011/0048858 A1
(43) Pub. Date: Mar. 3, 2011

(54) Power generation appratus and method

(76) Inventor: Max Cole, Sidney, AR (US)

(21) Appl. No.: 12/584,033

(22) Filed: Aug. 28, 2009

(51) Int. Cl. F03G 3/08

(52) U.S. Cl. 185/27

(57) ABSTRACT

Embodiments include a method and apparatus for providing power. In some embodiments, the apparatus comprises a first assembly and second assembly which use centrifugal force to generate power. In some embodiments, the apparatus comprises a method for producing power using centrifugal force from the first and second assembly.

### BACKGROUND OF THE INVENTION

1. Field of the Invention

Embodiments of the present invention generally relate to a power generation apparatus and method.

2. Description of the Related Art

Recent energy crises highlight a downside of the use of fossil fuels to power machines such as automobiles as well as homes and other spaces. Fossil fuels such as gasoline are of finite supply which eventually will be exhausted, thus requiring alternative energy sources. Additionally, as long as fossil fuel remains the energy source for the United States, our dependence on foreign countries who possess the supply of fossil fuel is increased, resulting in volatility in price and supply available.

It is therefore desirable to provide a power source which limits or eliminates the use of fossil fuels.

### SUMMARY OF THE INVENTION

Embodiments generally include a power source which limits or eliminates the use of fossil fuels.

Embodiments generally include a powering apparatus, comprising a first assembly, comprising at least two wheels operatively connected to one another to rotate together, and at least one weight member operatively attached to at least one of the wheels, the at least one weight member for providing centrifugal force to rotate the at least two wheels; a second assembly comprising at least two flywheels operatively connected to one another to rotate together, and a pumping mechanism operatively connected to at least one of the flywheels; and at least one drive shaft operatively connecting the first assembly to the second assembly.

Further embodiments include a method of power generation, comprising providing an apparatus comprising a first assembly, comprising at least two wheels operatively connected to one another, and at least one weight member operatively attached to at least one of the wheels; a second assembly comprising at least two flywheels operatively connected to one another, and a pumping mechanism operatively connected to at least one of the flywheels; and at least one drive shaft operatively connecting the first assembly to the second assembly; providing the at least one weight member in an initial position; providing an initiating force to the weight member to initiate downward movement of the weight member along with rotation of the at least two wheels; using centrifugal force to rotate the at least two wheels; and transferring the centrifugal force to the at least two flywheels using the at least one drive shaft to rotate the at least two flywheels.

### BRIEF DESCRIPTION OF THE DRAWINGS

So that the manner in which the above-recited features of embodiments of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of an embodiment of a power generation system.

### DETAILED DESCRIPTION

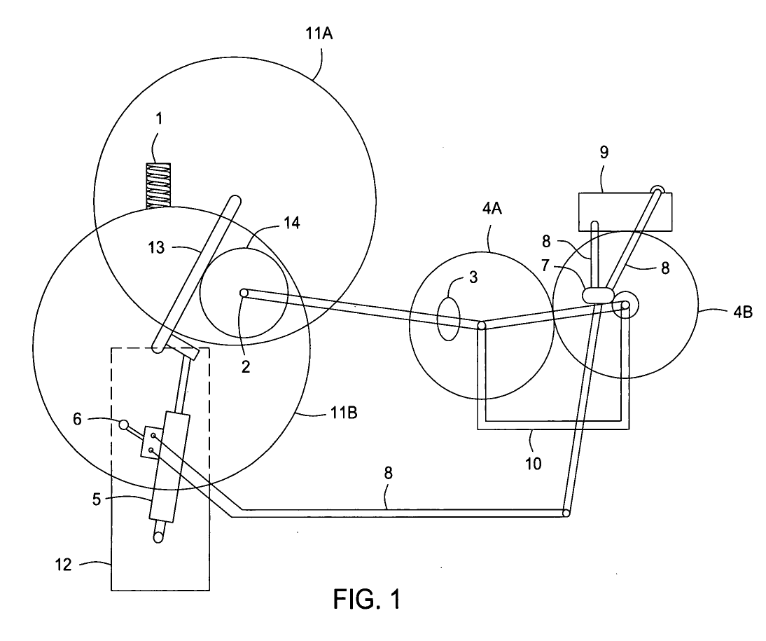

Embodiments generally include an apparatus and method for producing power. This apparatus and method may be used as power, e.g., for pulling a loaded rail car, for powering machinery to remove oil from oil fields, or for substituting for electricity in a home or other space. Gasoline is not necessary for the power source to produce power. In some embodiments, the apparatus and methods of embodiments are capable of providing at least 10 horsepower (e.g., using approximately 42-inch flywheels 4A, 4B as described below and shown in FIG. 1).

In the embodiment shown in FIG. 1, a first wheel 11A and second wheel 11B are operatively connected to one another via axle 13 and through drive or motor 14. The first wheel 11A and second wheel 11B may be, for example, tractor wheels or wheels of comparable size, or in the alternative may be any wheels known to those skilled in the art. The wheels 11A and 11B may be of the same size or of different sizes. The wheels 11A, 11B are rotatable around their respective central axes. One or more supports 12 may be used to support the wheels 11A, 11B at a height above a ground surface.

The second wheel 11B possesses one or more weights 1 thereon, for example one or more springs or weight-producing structures (e.g., steel structures or structures including other metals). The one or more weights 1 may be operatively attached to any portion of the second wheel 11B, but more preferably are attached to an outer diameter surface of the second wheel 11B as shown in FIG. 1. In an embodiment, the weight is a spring weighing approximately 500 pounds, but any weight of the spring is contemplated by the inventor. In another embodiment, the weight includes ½-inch steel cut into approximately 12-foot by 12-foot pieces.

The apparatus and method includes a first assembly including the first and second wheels 11A, 11B and a drive and power take-off (“PTO”) drive shaft 2. Between the two wheels 11A and 11B is the PTO drive shaft 2, such as the PTO drive shaft found on most tractors and typically used for transferring mechanical or rotary power from the tractor to a farm implement (the drive shaft is typically splined). The PTO drive shaft 2 is preferably capable of producing approximately 500 revolutions per minute (rpm) in wheels 4 and 4B (see description below), but may be capable of producing any amount of revolutions per minute.

Also operatively attached to a central axis of the second wheel 11B are one or more hydraulic cylinders 5. In an alternate embodiment, the one or more hydraulic cylinders may be replaced with or supplemented with one or more pneumatic cylinders. Hydraulic lines 8 are operatively attached to the hydraulic cylinder 5. One or more hydraulic directional valves 6 are operatively connected to the hydraulic lines 8 to control the motion of the hydraulic cylinder 5. The hydraulic directional valve 6 may include any hydraulic directional valve known to those skilled in the art for controlling the motion of a hydraulic cylinder.

The drive shaft 2 and the hydraulic lines 8 are operatively connected to a second set of wheels which operate as flywheels. The second set of wheels includes a first flywheel 4A and a second flywheel 4B which are operatively connected to one another (such as by a shaft). The first and second flywheels 4A and 4B are mounted on a support 10 which maintains the position of the flywheels 4A and 4B at a height above the ground surface. The flywheels 4A and 4B may be of the same size or of similar or different sizes. The size of one or more of the flywheels 4A, 4B may be adjusted according to the size of the load for which power must be provided, for example larger loads may require larger flywheels 4A, 4B. One or more override clutches 3 may be operatively attached to the flywheel 4A (e.g., via the drive shaft 2).

The hydraulic lines 8 are operatively connected to the flywheels via one or more hydraulic pumps 7. The apparatus and method includes, in addition to the first assembly, a second assembly which includes the flywheels 4A and 4B and the hydraulic pump(s) 7. Hydraulic lines 8 (e.g., hydraulic hoses or pipes) run to and from one or more hydraulic oil tanks 9 for supplying the hydraulic cylinder 5 via the hydraulic pump 7. The recirculating hydraulic lines 8 operatively connect the first assembly and the second assembly to one another and are used for recirculating the hydraulic fluid (which may be oil). The hydraulic pump 7 provides additional pressure to the oil flowing through the hydraulic lines 8 to the hydraulic cylinder 5. The hydraulic pump 7 may be, for example, one used for a wood splitter.

In operation, gravity or a pull from the weight or spring 1 begins centrifugal force on the wheels 11A and 11B. The drive and PTO drive shaft 2 turns the wheels 4A and 4B very fast (e.g., approximately 500-600 revolutions per minute by the time the weight arrives at the bottom of the rotational movement of the wheel). The centrifugal force pulls the hydraulic pump 7, resetting the weight 1 (to the top of the rotational movement of the wheel) to pull the wheels 11A and 11B via the centrifugal force. This process repeats to continually produce power.

In some embodiments using the apparatus and methods shown and described above, an oil well pumping unit with approximately 72-inch flywheels weighing approximately 2000 pounds or more running approximately 450 revolutions per minute (rpm) may pump oil and generate electricity. In other embodiments, the apparatus and methods shown and described above may be utilized in outer space with springs and magnets, where springs and magnets are needed for gravity.

In the embodiments shown and described herein, the object used as the weight on the wheels 11A and 11B may be any type of object known to those skilled in the art capable of producing weight on the wheels 11A, 11B, and the form of the weight may vary. For example, one or more levers may be used as the weight rather than or in addition to the spring. Additionally, although two wheels 11A, 11B and two flywheels 4A, 4B are shown and described in embodiments disclosed herein, the amount and number of wheels and flywheels may vary as desired.

While the foregoing is directed to embodiments, other and further embodiments of the invention may be devised without departing from the basic scope thereof, and the scope thereof is determined by the claims that follow.

1. A powering apparatus, comprising:
a first assembly, comprising:
at least two wheels operatively connected to one another to rotate together, and
at least one weight member operatively attached to at least one of the wheels, the at least one weight member for providing centrifugal force to rotate the at least two wheels;
a second assembly comprising:
at least two flywheels operatively connected to one another to rotate together, and
a pumping mechanism operatively connected to at least one of the flywheels; and
at least one drive shaft operatively connecting the first assembly to the second assembly.

2. The apparatus of claim 1, further comprising:
a hydraulic cylinder operatively attached to the first assembly; and
one or more hydraulic lines connecting the pumping mechanism to the hydraulic cylinder, wherein the pumping mechanism is a hydraulic pump.

3. The apparatus of claim 1, wherein the weight member is a steel structure.

4. The apparatus of claim 1, wherein the weight member is a spring.

5. The apparatus of claim 1, wherein the at least one drive shaft is at least one power take-off drive shaft.

6. The apparatus of claim 5, further comprising a drive disposed between the at least two wheels and operatively connecting the at least two wheels to the power take-off drive shaft.

7. The apparatus of claim 1, further comprising an override clutch member operatively attached to the second assembly.

8. A method of power generation, comprising:
providing an apparatus comprising:
a first assembly, comprising:
at least two wheels operatively connected to one another, and
at least one weight member operatively attached to at least one of the wheels;
a second assembly comprising:
at least two flywheels operatively connected to one another, and
a pumping mechanism operatively connected to at least one of the flywheels; and
at least one drive shaft operatively connecting the first assembly to the second assembly;
providing the at least one weight member in an initial position;
providing an initiating force to the weight member to initiate downward movement of the weight member along with rotation of the at least two wheels;
using centrifugal force to rotate the at least two wheels; and
transferring the centrifugal force to the at least two flywheels using the at least one drive shaft to rotate the at least two flywheels.

9. The method of claim 8, wherein the apparatus further comprises:
a hydraulic cylinder operatively connected to at least one of the at least two wheels; and
one or more hydraulic lines connected at a first end to the hydraulic cylinder and at a second end to the pumping mechanism.

10. The method of claim 9, further comprising using the transferred centrifugal force to power the pumping mechanism.

11. The method of claim 10, further comprising circulating hydraulic fluid from the pumping mechanism to the hydraulic cylinder using one or more of the hydraulic lines.

12. The method of claim 11, further comprising recirculating the hydraulic fluid from the hydraulic cylinder to the pumping mechanism using one or more of the hydraulic lines.

13. The method of claim 11, further comprising moving the at least one weight member to its initial position using the hydraulic cylinder.

14. The method of claim 13, wherein the initiating force comprises a pulling force.

15. The method of claim 13, wherein the at least one weight member is a spring mechanism, and wherein the initiating force is tension from the spring mechanism.

16. The method of claim 13, wherein the at least one weight member is a metal structure.

17. The method of claim 13, further comprising performing the method again by providing an initiating force to the weight member to initiate downward movement of the weight member along with rotation of the at least two wheels.

18. The method of claim 13, further comprising providing generating power using the method.

19. The method of claim 11, wherein the apparatus further comprises an override clutch member, and further comprising halting the rotation of the at least two flywheels using the override clutch member.

20. The method of claim 11, wherein:
the hydraulic fluid is oil; and
oil is the only fluid necessary to generate power using the apparatus.
